(19) United States
(12) Patent Application Publication
(10) Pub. No.: US 2008/0032277 A1
(43) Pub. Date: Feb. 7, 2008

(54) DYNAMIC MULTIPLE CHOICE ANSWERS

(75) Inventors: Frank S. Maggio, Pinellas Park, FL (US); Steven Anthony Granese, St. Petersburg, FL (US)

Correspondence Address: KING & SPALDING LLP, 1180 PEACHTREE STREET, ATLANTA, GA, 30309-3521, US

(73) Assignee: Media IP Holdings, LLC, St. Petersburg, FL (US)

(21) Appl. No.: 11/697,569

(22) Filed: Apr. 6, 2007

Related U.S. Application Data
(60) Provisional application No. 60/790,195, filed on Apr. 8, 2006.

(51) Int. Cl. G09B 7/04

(52) U.S. Cl. 434/362

(57) ABSTRACT

Presenting answers to a plurality of recipients comprises presenting media content to the recipients, presenting a question based on the content to the recipients, and presenting answers to the recipients. The answers presented to one recipient are different from the answers presented to another recipient. The answers can be different for each recipient based on a random order assigned to the choices for each recipient. The answers can be different for each recipient based on different choices presented to each recipient. The correct answer presented to a recipient can change over time depending on the choices presented to the recipients. Each recipient can submit a response to the question by selecting one of the answers, where a correct response suggests or verifies that the correctly-responding recipient was exposed to the content. Correctly-responding recipients can qualify for a prize. The media content can comprise one or more advertisements or entertainment content.

### RELATED APPLICATIONS

This patent application claims priority under 35 U.S.C. § 119 to U.S. Provisional Patent Application No. 60/790,195, entitled “Dynamic Multiple Choice Answers,” filed Apr. 8, 2006. This Application also is related to U.S. patent application Ser. No. 11/397,481, entitled “Method and System for Substituting Media Content,” filed in the U.S. Patent and Trademark Office on Apr. 4, 2006. The complete disclosure of each of the above-identified priority and related patent applications is hereby fully incorporated herein by reference.

### TECHNICAL FIELD

The invention relates to questions and answers presented via multiple media in multiple markets. In particular, the invention relates to presenting different answers to each of multiple recipients of the same question.

### BACKGROUND

When games are played across multiple time zones or via multiple media, participants can “cheat” by sharing information between each other. For example, a participant playing the game in a first time zone may receive questions and answers before a participant playing the game in a second time zone. Alternatively, a participant playing the game via a first media, such as television, may receive questions and answers before a participant playing the game via a second media, such as the Internet. Accordingly, the first participant can communicate the answers to the second participant, thereby allowing the second participant to answer the questions correctly without playing the game. Such “cheating” can decrease the actual participation in the game by decreasing other participants' willingness to compete in the game. Additionally, such “cheating” can decrease an advertiser's willingness to sponsor the game.

Furthermore, conventional question and answer games include a presentation of a question to the players and a presentation of an answer set from which the players may choose an answer to the question. Typically, the answer set is presented in a multiple choice format. A time period for responding to the question is provided, and the points awarded for selecting an answer decrease as time elapses. A player selects an answer to the question, and then waits for the time period to elapse, at which time the game will notify the player if his selected answer was correct. If correct, the player is awarded the points that were available when the player selected the answer. If incorrect, the player is not awarded the points. Thus, if the player selects an answer quickly, then that player may become bored and may disengage from the game while waiting for the time period to pass. Additionally, it is easy for players to cheat because the correct answer in the answer set is fixed and because they can observe other player's answer selections.

To address the representative deficiencies in the field, a need exists for preventing cheating in games played in multiple time zones, in multiple time slots, or via multiple media. Accordingly, a need exists to allow participants to play the same game at different times or via different media but using the same questions, while decreasing the participants' ability to cheat. Furthermore, a need exists in the art for keeping players engaged in a game while the time period for responding elapses.

### SUMMARY OF THE INVENTION

The invention described herein can allow multiple participants to play the same game at different times or via different media with a decreased ability for the participants to cheat. The invention can provide the same question to the participants combined with a different set of answers presented to each participant. Accordingly, the participants cannot share answers to the questions because each participant's correct answer is different.

In one aspect, presenting answers to a plurality of recipients comprises presenting media content to the recipients, presenting a question based on the content to the recipients, and presenting answers to the recipients. The answers presented to one recipient are different from the answers presented to another recipient. The answers can be different for each recipient based on a random order assigned to the choices for each recipient. Alternatively, the answers can be different for each recipient based on different choices presented to each recipient. Additionally, the correct answer presented to a recipient can change over time. Each recipient can submit a response to the question by selecting one of the answers, where a correct response suggests or verifies that the correctly-responding recipient was exposed to the presented content. Correctly-responding recipients can qualify for a prize. The media content can comprise one or more advertisements, commercials, or entertainment content.

In another aspect, presenting answers to a question includes presenting an initial set of answers, replacing one of the presented answers with a new answer, striking out one of the presented answers, and removing one of the presented answers. The winning answer can change during a time period for response to the question based on the replaced or removed answers. Thus, players remain engaged in the game throughout the time period for responding because they may have to select a different answer if their previously-selected answer changes or if a better answer (in their opinion) is presented.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for dynamically presenting multiple choice answers to multiple recipients of the same question according to an exemplary embodiment of the invention.

FIG. 2 is a flow chart depicting a method for dynamically presenting multiple choice answers to multiple recipients of the same question according to an exemplary embodiment of the invention.

FIG. 3 is a flow chart depicting a method for defining potentially correct answers, which are correct when presented in combination with corresponding true or false answers, according to an exemplary embodiment of the invention.

FIG. 4 is a flow chart depicting a method for presenting random answers to the recipients according to an exemplary embodiment of the invention.

FIG. 5 is a flow chart depicting a method for presenting different answers to the recipients according to an exemplary embodiment of the invention.

FIGS. 6A and 6B are flow charts depicting a method for presenting changing answers to the recipients according to an exemplary embodiment of the invention.

FIG. 7 is a flow chart depicting a method for determining whether the recipients correctly responded to the question according to an exemplary embodiment of the invention.

FIG. 8 is a flow chart depicting a method for playing a game using a question with different answers for multiple players according to an exemplary embodiment of the invention.

FIGS. 9A and 9B are flowcharts depicting a method for generating an initial answer set for a question according to an exemplary embodiment of the invention.

FIGS. 10A and 10B are flowcharts depicting a method for changing answers presented to players of a game according to an exemplary embodiment of the invention.

FIG. 11 is a flow chart depicting a method for determining whether a player correctly responded to a question according to an exemplary embodiment of the invention.

FIG. 12 is a flow chart depicting a method for playing a game based on questions and dynamic multiple choice answers according to an exemplary embodiment of the invention.

Many aspects of the invention can be better understood with reference to the above drawings. The components in the drawings are not necessarily to scale, emphasis being placed instead upon clearly illustrating the principles of exemplary embodiments of the invention. Additionally, reference numerals in the drawings designate corresponding, but not necessarily identical, parts throughout the different views.

### DETAILED DESCRIPTION OF THE EXEMPLARY EMBODIMENTS

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

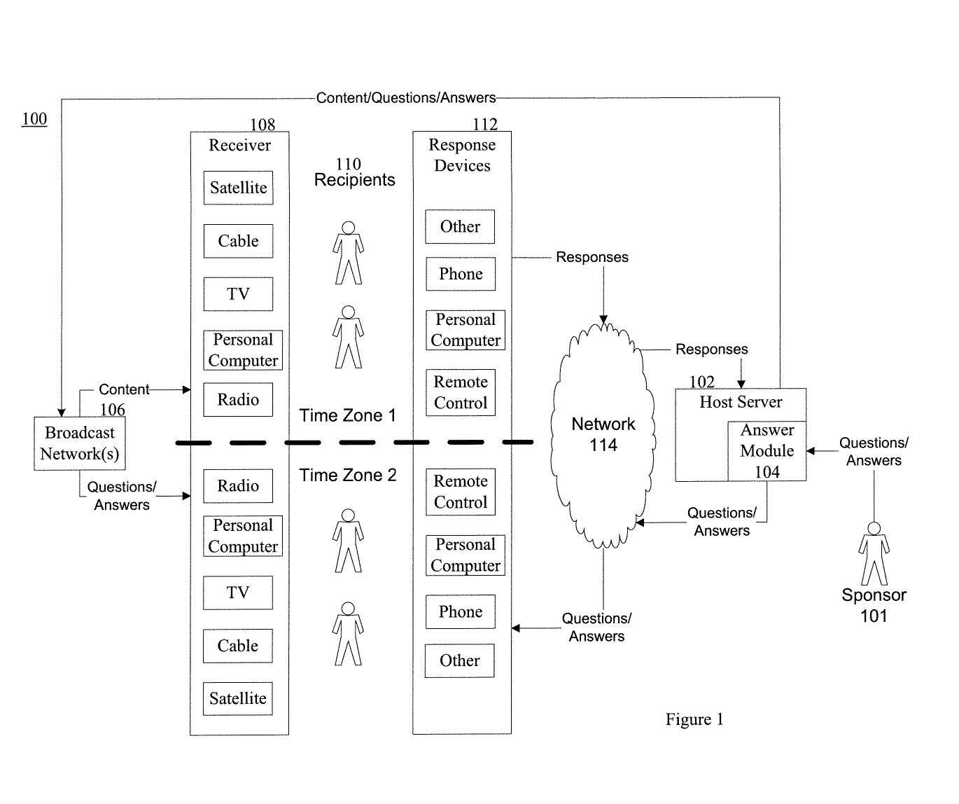

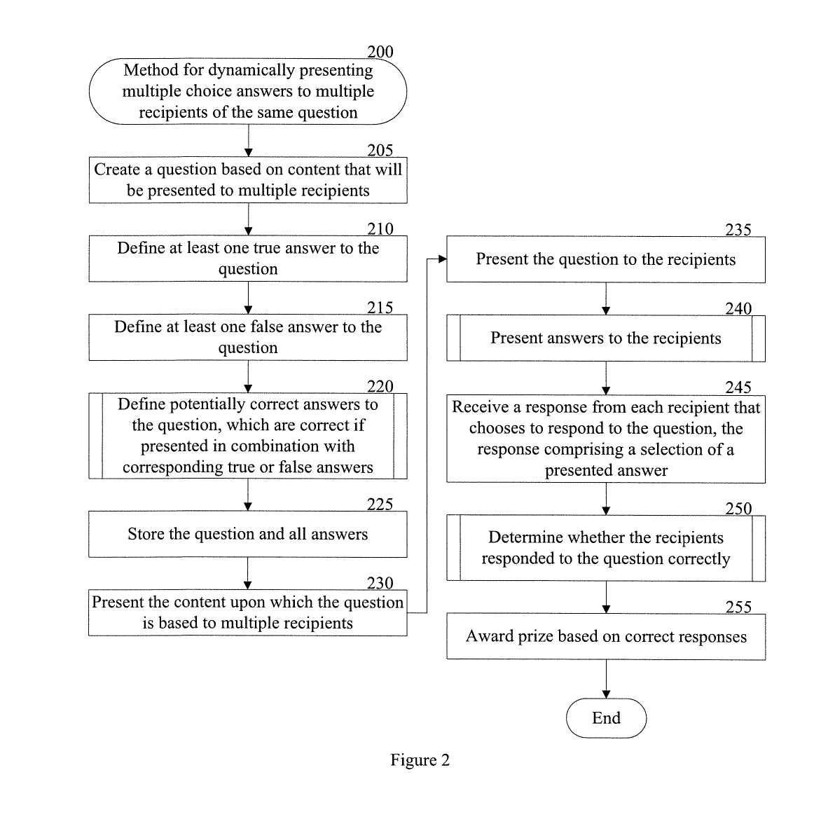

A method and system for dynamically presenting multiple choice answers to multiple recipients 110 will now be described with reference to FIGS. 1-12, which depict representative or illustrative embodiments of the invention. FIG. 1 is a block diagram depicting a system 100 for dynamically presenting multiple choice answers to multiple recipients 110 of the same question according to an exemplary embodiment of the invention. The parties and structure depicted in FIG. 1 will be discussed in more detail with reference to the methods illustrated in FIGS. 2-12.

FIG. 2 is a flow chart depicting a method 200 for dynamically presenting multiple choice answers to multiple recipients 110 of the same question according to an exemplary embodiment of the invention. The method 200 will be described with reference to FIGS. 1 and 2.

In step 205, a sponsor 101 creates a question based on content that will be presented to multiple recipients 110. In an exemplary embodiment, the content can comprise entertainment content, advertising content, or other suitable content presented to recipients 110 via one or more broadcast networks 106. For example, entertainment content can comprise movies, sit-coms, sporting events, soap operas, game shows, pay-per-view events, video-on-demand content, combinations of the forgoing, or other suitable entertainment content. Additionally, exemplary advertising content can comprise commercials, groups of commercials, paid programming, infomercials, combinations of the forgoing, or other suitable advertising content.

Accordingly, the sponsor 101 can create a question based on information in the content that will be presented to the multiple recipients 110 via the broadcast networks 106. For example, if advertising content describes a green car for sale by a manufacturer, then a sponsor 101 can create a question that asks, “What color is the car described in the advertisement?”. In an exemplary embodiment, the sponsor 101 can create the question by inputting the question into the host server 102, which stores the question for later use.

In an alternative exemplary embodiment, the sponsor can create or input any type of question for which true and false answers can be created. For example, such questions can comprise trivia questions.

In step 210, the sponsor 101 defines at least one true answer to the question created in step 205. In an exemplary embodiment, the sponsor 101 can define each true answer by inputting each true answer into the host server 102, which associates the true answer with the question. A “true” answer is an answer that directly answers the question correctly. For example, “green” is the true answer to the exemplary question discussed with reference to step 205. Accordingly, the sponsor 101 can input the true answer “green” into the host server 102, and the host server 102 can associate the true answer with the question.

In step 215, the sponsor 101 defines at least one false answer to the question created in step 205. In an exemplary embodiment, the sponsor 101 can define each false answer by inputting one or more false answers into the host server 102, which associates the false answers with the question. For example, the sponsor 101 can input “blue,” “red,” and “yellow” as false answers into the host server 102 for the exemplary question discussed above with reference to step 205, and the host server 102 can associate each false answer with the question. A “false” answer is an answer that is not correct or is not the best answer.

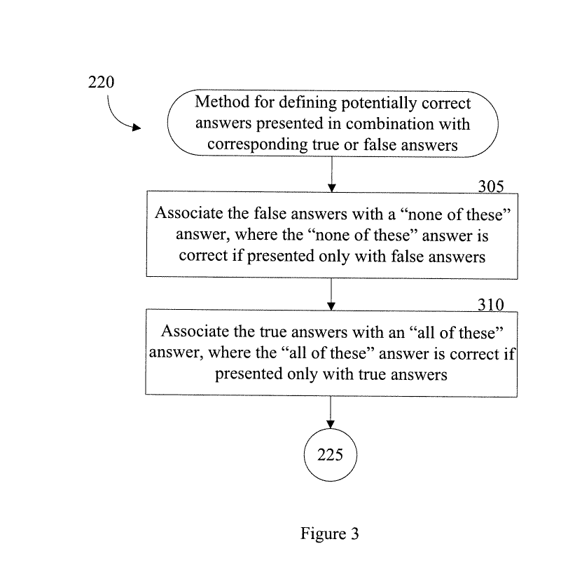

In step 220, potentially correct answers to the question are defined, where the potentially correct answers are correct if presented in combination with corresponding true or false answers. Potentially correct answers comprise a “none of these” answer and an “all of these” answer. A “none of these” answer is synonymous with a “none of the above” answer, except that a “none of the above” answer must be presented at the bottom of a list of answers. An “all of these” answer is synonymous with an “all of the above” answer, except that an “all of the above” answer must be presented at the bottom of a list of answers. Step 220 will be discussed in more detail hereafter with reference to FIG. 3.

In step 225, the host server 102 stores the question and all answers for later retrieval by the answer module 104. In an exemplary embodiment, the host server 102 can communicate the question and all answers associated with the question to the answer module 104, which can store the question and all answers for later presentation to the recipients 110. Alternatively, the answer module 104 can access the question and all answers stored on the host server 102 or another device (not shown) for presentation to the recipients 110.

In step 230, one or more of the broadcast networks 106 presents the content upon which the question is based to multiple recipients 110. In that regard, the broadcast networks 106 can communicate the content to one or more receivers 108 for presentation to the recipients 110. Each receiver 108 corresponds to a type of broadcast network 106 with which it is associated. For example, (1) if the broadcast network 106 comprises a satellite network, then the receiver 108 can comprise a satellite receiver 108 that receives and presents the content to a recipient 110 via a television; (2) if the broadcast network 106 comprises a cable network, then the receiver 108 can comprise a cable receiver, such as a cable set-top box, that receives and presents the content to a recipient 110 via a television; (3) if the broadcast network 106 comprises an over-the-air broadcast television network, then the receiver 108 can comprise a television or television/antenna combination that receives and presents the content to a recipient 110 via the television; (4) if the broadcast network 106 comprises a packet-switched network, such as the Internet, then the receiver 108 can comprise a personal computer with access to that network, which receives and presents the content to a recipient 110 via the personal computer; and (5) if the broadcast network 106 comprises a radio network, then the receiver 108 can comprise a radio receiver that receives and presents the content to a recipient 110 via the radio. In an alternative embodiment, the broadcast network 106 can comprise a wireless network such as a WiMax or WiFi network, and the receiver 108 can comprise any device capable of communicating over such a network, such as an information processing unit, PDA, or cellular phone. Other suitable broadcast networks 106 and associated receivers/presentation devices 108 are within the scope of the exemplary embodiments.

As illustrated in FIG. 1, multiple recipients 110 can receive the same content at the same time via the same or different types of networks and receivers 108. Additionally, multiple recipients 110 can receive the same content via networks and receivers 108 in different time zones. That content can be presented at the same time in the different time zones. Alternatively, that content can be presented at different times in different time zones based on different viewing schedules.

In an exemplary embodiment, if the question comprises a trivia question, then step 230 is not needed because the questions are not based on presented content.

In step 235, the question based on the presented content, if any, is presented to the recipients 110. The question can be presented to the recipients 110 via various methods. In an exemplary embodiment, the host server 102 can communicate the question to the broadcast network 106, the broadcast network 106 can communicate the question to the receiver 108, and the receiver 108 can present the question to the recipients 110. In an alternatively exemplary embodiment, the host server 102 can communicate the question to a response device 112 via a network 114 for presentation to the recipients 110. In another alternative exemplary embodiment, the answer module 104 can communicate the question to a response device 112 via the network 114 for presentation to the recipients 110. The recipients 110 submit responses to the question via the response devices 112.

As illustrated in FIG. 1, the response devices 112 can comprise a phone, such as a telephone or a wireless communication device, an Internet-enabled personal computer, a remote control unit with Internet connectivity, or any other suitable device capable of communicating with the host server 102 via a suitable network 114. Exemplary suitable networks 114 can comprise the Internet for communications between the host server 102 and an Internet-enabled personal computer or a remote control unit with Internet connectivity; a public switched telephone network for communications between the host server 102 and a telephone; and a satellite or cellular network for communications between the host server 102 and a wireless phone. Other “networks” can comprise wireless communications between the host server and another type of response device capable of wireless communications, such as a response device used for trivia games at local establishments.

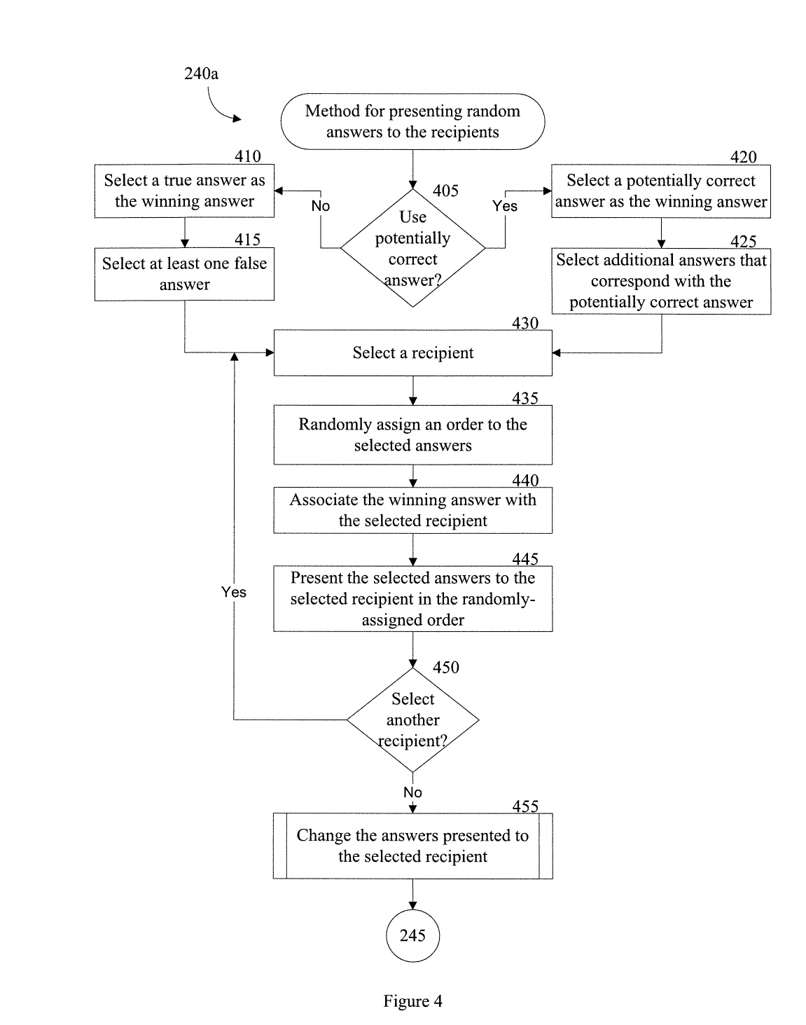

In step 240, the answer module 104 presents answers comprising one or more of the answers defined in steps 210, 215, and/or 220 to the recipients 110. Step 240 will be discussed in further detail hereafter with reference to FIGS. 4, 5, 6A, and 6B. Then, in step 245, the host server 102 receives a response from each recipient 110 that chooses to respond to the question. Each response comprises the responding recipient's selection of a presented answer.

The recipients 110 can submit a response to the host server 102 via the various response devices 112 illustrated in FIG. 1 and the network 114 that corresponds to each response device 112. In an exemplary embodiment, a recipient 110 can contact the host server 102 via telephone or wireless phone, and the host computer can present the question and/or the answers to the recipient 110. In this case, the network 114 can comprise a public switched telephone network or a wireless communication network, respectively. Then, the recipient 110 can select one of the presented answers and submit that answer to the host server 102 via the telephone or wireless phone. In an exemplary embodiment, the host server 102 can communicate with the recipient 110 via an interactive voice response mechanism.

In an alternative exemplary embodiment, a recipient 110 can contact the host server 102 via an Internet-enabled personal computer, which can present the question and/or answers to the recipient 110. In this case, the network 114 can comprise the Internet. In this embodiment, the host server 102 can present the question and/or answers to the recipient 110 by communicating those items via the Internet to the Internet-enabled personal computer for presentation to the recipient 110. Then, the recipient 110 can select one of the presented answers on the personal computer, which can communicate the recipient's 110 selected answer from the personal computer to the host server 102 via the Internet.

In another alternative exemplary embodiment, the host server 102 can present the question and/or answers to a recipient 110 via an Internet-enabled remote control device, which can present the question and/or answers to the recipient 110. In this case, the network 114 can comprise the Internet. An exemplary Internet-enabled remote control device can have a hand-held form factor and can generate control signals for the appropriate receiver 108 to control a channel selection for receiving the content from the broadcast network 106. The exemplary remote control device also can comprise a display screen via which it can present the question and/or answers received from the host server 102 to the recipient 110. Additionally, the exemplary remote control device can include an input device via which the recipient 110 can input a selection of one of the presented answers. Then, the exemplary remote control device can communicate the selected answer to the host server 102 via the Internet.

The remote control form factor and functionality of a hand-held remote control device allow operators to replace other remote controls with the hand-held device, as people often do by utilizing a “universal” remote control. Additionally, the hand-held device's ergonomic design and ability to send and receive data via the Internet encourages operators to utilize the hand-held device while in the television viewing venue. Although several devices exist, such as laptop computers, personal digital assistants (PDAs), and cellular phones, that are capable of accessing the Internet, the form factor of the hand-held device is separate and distinct from any other form factor, in that it appears and feels similar to standard remote controls. Remote controls are differentiated in retail outlets and in the mind of consumers, and have earned a distinctive position as a device within the television viewing venue. Because people are either right handed or left handed, one and only one device can earn the right to be the “palm habitant” while experiencing television, as the mouse has done in the computer environment. Also, an entire sub-industry of replacement remote controls exists in which the hand-held device would qualify for consideration. A laptop, PDA, or cellular phone, however, would not qualify as such a replacement because of their form factor. There is a science to migrating applications to a remote control form factor so as to win the sole right to control the palm of the television viewer; the form factor of the hand-held device takes this science into account.

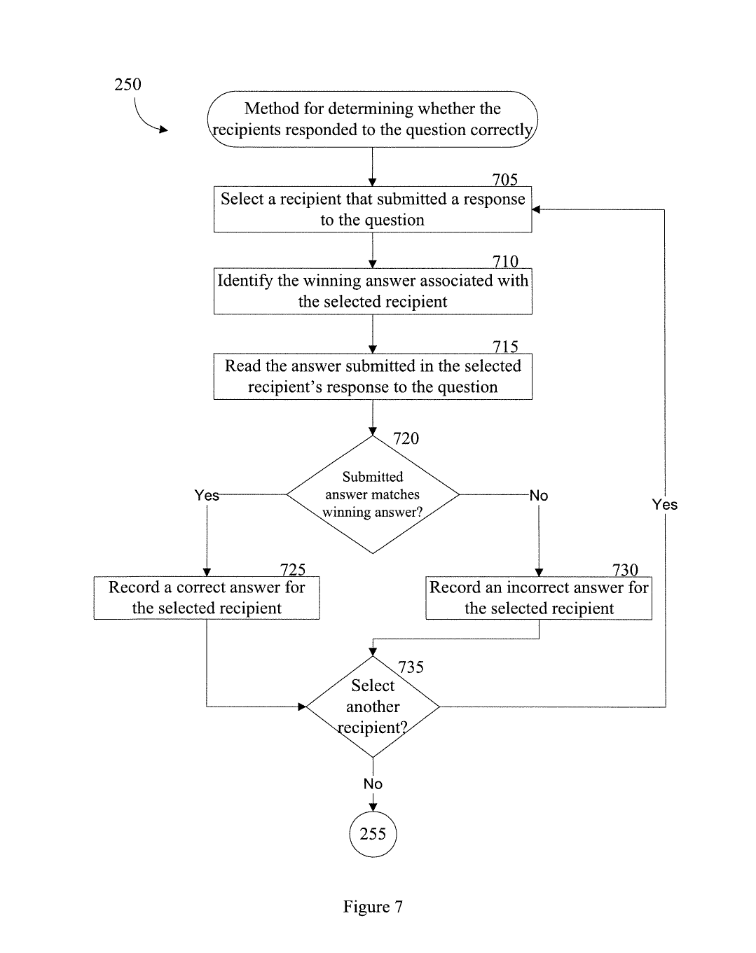

In step 250, the answer module 104 determines whether the recipients 110 responded to the question correctly. Step 250 will be discussed in more detail hereafter with reference to FIG. 7. Then, in step 255, the sponsor 101 awards a prize to one or more of the recipients 110 based on correct responses to the question. In an exemplary embodiment, submitting a correct response to the question can qualify the correctly-responding recipient 110 for a prize pool, and the sponsor 101 can award a prize to one or more of the recipients 110 in the prize pool.

In exemplary embodiments, the prize can comprise cash, coupons, free samples, products, services, points, or other suitable rewards. The potential to receive a reward can create a desire for the recipients 110 to view the content, receive the question, and submit a response to the question. Accordingly, the potential to receive a reward entices the recipients 110 to pay attention to the broadcast content. Additionally, a true response submitted by a recipient 110 indicates that the responding recipient 110 likely was exposed to the broadcast content since the recipient 110 was able to answer the question correctly. Such “immersion” information indicating that the recipient 110 experienced the content can be valuable to advertisers and others. For example, advertisers can better determine how many recipients 110 actually watched a specific advertisement. Additionally, advertisers can be charged based on the number of recipients 110 that actually watched the advertisement, based on the submitted responses to the questions, particularly the true responses.

In an exemplary game embodiment, points can be awarded to each recipient that correctly responds to the question. Then, the recipient with the most points after a predetermined number of questions can be the winner. The winning recipient can be presented a prize, or the winning recipient can become eligible for a prize pool from which one of the members of the pool will eventually win a prize.

From step 255, the method 200 ends.

FIG. 3 is a flow chart depicting a method 220 for defining potentially correct answers, which are correct when presented in combination with corresponding true or false answers, according to an exemplary embodiment of the invention, as referenced in step 220 of FIG. 2. The method 300 will be described with reference to FIGS. 1 and 3.

In step 305, the answer module 104 associates the false answers defined in step 215 with a “none of these” answer. The “none of these” answer is correct if presented only with the associated false answers. Additionally, in step 310, the answer module 104 associates the true answers defined in step 210 with an “all of these” answer. The “all of these” answer is correct if presented only with true answers. From step 310, the method 220 proceeds to step 225 (FIG. 2).

Because the content is provided via multiple receivers 108 and/or at different times to the recipients 110, the recipients 110 could collude to answer questions about the content. For example, a recipient 110 receiving the content in time zone 1 at a first time could communicate to a recipient 110 receiving the content in time zone 2 at a second time. By that communication, the recipient 110 in time zone 1 can provide information to the recipient 110 in time zone 2 to allow that recipient 110 to properly answer one or more questions about the content. Thus, if both recipients 110 received the same question with the same answers, then the first recipient 110 can provide the correct answer to the second recipient 110. Then, the second recipient 110 could answer the question correctly and become eligible for a prize without becoming exposed to the content upon which the question is based. Such collusion also could occur based on even small delays between presentation of the questions and answers, which could occur on different broadcast networks 106. For example, the first recipient 110 might receive the content, questions, and or answers sooner via a cable network, and the second recipient 110 might receive those items later via the Internet.

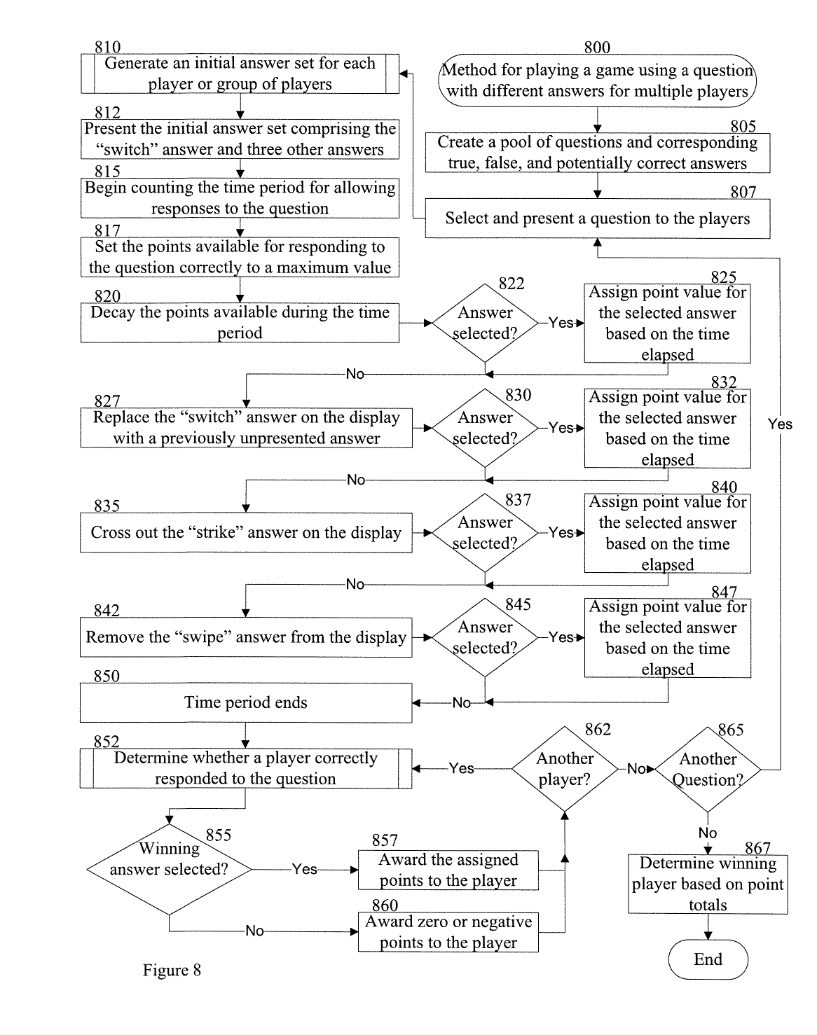

To reduce such collusion between the recipients 110, the method 200 can present answers to the recipients 110 via the exemplary embodiments described herein and referenced in step 240 of FIG. 2, which methods increase the difficulty for the recipients 110 to collude. Such exemplary methods 240 for presenting answers to the recipients 110 will be described with reference to FIGS. 4, 5, 6A, and 6B. Additionally, the exemplary methods described with reference to FIGS. 8-12 also increase the difficulty for the recipients to collude. Furthermore, the dynamic aspects regarding the changing answers presented to the recipients/players keeps the recipients/players engaged throughout the response period.

FIG. 4 is a flow chart depicting a method 240a for presenting random answers to the recipients 110 according to an exemplary embodiment of the invention, as referenced in step 240 of FIG. 2. The method 240a will be described with reference to FIGS. 1 and 4.

In step 405, the answer module 104 determines whether potentially correct answers will be presented to the recipients 110. If not, the method branches to step 410.

In step 410, the answer module 104 selects a true answer from the answers defined in step 210 (FIG. 2). In this case, the true answer will be the first winning answer presented to the recipient. The “winning” answer is the correct answer being presented to the recipient, the selection of which is a correct response to the question. Then, in step 415, the answer module 104 selects at least one false answer from the answers defined in step 215 (FIG. 2). The method 240a then proceeds to step 430 discussed later.

Referring back to step 405, if the answer module 104 determines that potentially correct answers will be used, then the method 240a braches to step 420. In step 420, the answer module 104 selects a potentially correct answer defined in step 220 (FIG. 2). In this case, the potentially correct answer will be the first winning answer presented to the recipient. The potentially correct answer will comprise either “none of these” or “all of these.” Then, in step 425, the answer module 104 selects additional answers that correspond with the selected potentially correct answer. For example, if the answer module 104 selected the “none of these” answer, then the answer module 104 will select one or more false answers that correspond with that potentially correct answer. Alternatively, if the answer module 104 selected the “all of these” answer, then the answer module 104 will select one or more true answers that correspond with that potentially correct answer. From step 425, the method 240a proceeds to step 430.

In step 430, the answer module 104 selects a recipient 110 that will receive a set of answers. In an exemplary embodiment, the answer module 104 can select a recipient 110 based on the next recipient 110 that contacts the host server 102 via a response device 112 to receive the answers. In an alternative exemplary embodiment, the answer module 104 can select a recipient 110 based on the recipient 110 that accesses the device 112 that contains the answer module 104. For example, if the answer module 104 is deployed in the Internet-enabled remote control, then the answer module 104 can select the recipient 110 that is using the Internet-enabled remote control. Similarly, the answer module 104 can be deployed in the Internet-enabled personal computer and can select the recipient 110 operating that device 112.

In step 435, the answer module 104 randomly assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer.

In step 440, the answer module 104 determines which answer in the assigned order is the winning answer and associates the corresponding winning answer with the selected recipient 110. The answer module 104 can store that information for later use.

In step 445, the answer module 104 presents the answers to the selected recipient 110 in the randomly-assigned order via the response device 112 utilized by the selected recipient 110.

In step 450, the method 240a determines whether to select another recipient 110 to which it will present a set of answers. If yes, the method 240a branches back to step 430 to select a different recipient 110 and to assign randomly a different order to the selected answers to create a different set of answers for the new recipient 110. Accordingly, in this exemplary embodiment, each recipient 110 will receive the same answers. However, each recipient 110 will receive a set of answers having a randomly generated order for the answers.

Referring back to step 450, if the method 240a determines not to present a set of answers to another recipient 110, then the method 240a branches to step 245 (FIG. 2).

If the answer module 104 resides on the host server 102 as shown in FIG. 1 or in a central location, then the answer module 104 may generate a set of answers for multiple recipients 110. Alternatively, multiple answer modules 104 can be deployed to the recipients' 110 locations via the response devices 112 or via another computer/server (not shown) located in proximity to the response devices. In this case, each answer module 104 may generate a set of answers for only the recipient 110 using the response device 112 on which that answer module 104 is deployed or for only those recipients whose response device accesses the other computer/server.

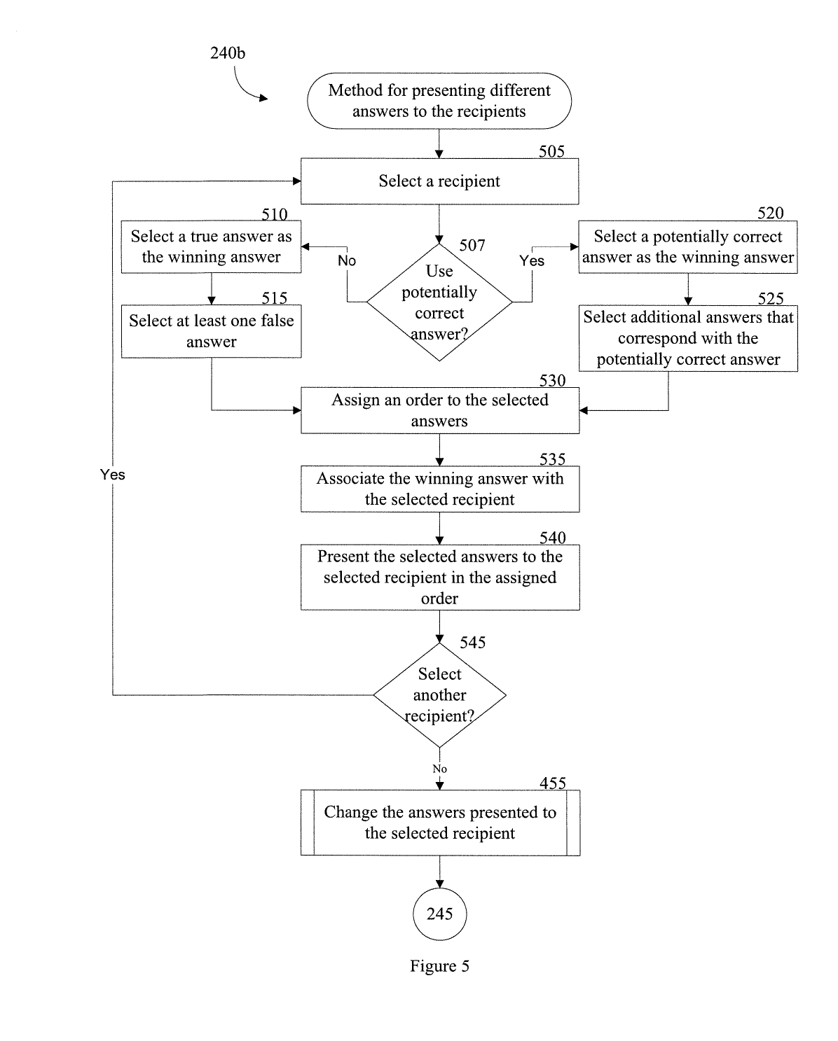

FIG. 5 is a flow chart depicting a method 240b for presenting different answers to the recipients 110 according to an exemplary embodiment of the invention, as referenced in step 240 of FIG. 2. The method 240b will be described with reference to FIGS. 1 and 5.

In step 505, the answer module 104 selects a recipient 110 that will receive a set of answers. The answer module 104 can select the recipient 110 in a manner similar to the selection described previously with respect to step 430 of FIG. 4.

In step 507, the answer module 104 determines whether potentially correct answers will be presented to the recipients 110. If not, the method branches to step 510.

In step 510, the answer module 104 selects a true answer from the answers defined in step 210 (FIG. 2). In this case, the true answer will be the first winning answer presented to the recipient. Then, in step 515, the answer module 104 selects at least one false answer from the answers defined in step 215 (FIG. 2). The method 240b then proceeds to step 530 discussed later.

Referring back to step 507, if the answer module 104 determines that potentially correct answers will be used, then the method 250b braches to step 520. In step 520, the answer module 104 selects a potentially correct answer defined in step 220 (FIG. 2). In this case, the potentially correct answer will be the first winning answer presented to the recipient. The potentially correct answer will comprise either “none of these” or “all of these.” Then, in step 525, the answer module 104 selects additional answers that correspond with the selected potentially correct answer. For example, if the answer module 104 selected the “none of these” answer, then the answer module 104 will select one or more false answers that correspond with that potentially correct answer. Alternatively, if the answer module 104 selected the “all of these” answer, then the answer module 104 will select one or more true answers that correspond with that potentially correct answer. From step 525, the method 240b proceeds to step 530.

In step 530, the answer module 104 assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer. In an exemplary embodiment, the answer module 104 can randomly assign an order to the selected answers.

In step 535, the answer module 104 determines which answer in the order is the winning answer and associates the corresponding winning answer with the selected recipient 110. The answer module 104 can store that information for later use.

In step 540, the answer module 104 presents the answers to the selected recipient 110 in the assigned order via the response device 112 utilized by the selected recipient 110.

In step 545, the method 240b determines whether to select another recipient 110 to which it will present a set of answers. If yes, the method 240b branches back to step 505 to select a different recipient 110, to select answers for that recipient 110, and to assign an order to the selected answers to create a different set of answers for that recipient 110. Accordingly, in this exemplary embodiment, each recipient 110 will receive a set of different answers, which can be presented in any of multiple assigned orders.

Those skilled in the art will understand that the number of different sets of answers available for presentation to the recipients 110 is limited by the number of defined answers and the number of answers that will be presented to each viewer. Accordingly, some recipients may receive the same answers. However, the recipients may not know that they have the same answers because of the different combinations of available answers.

Referring back to step 550, if the method 240b determines not to present a set of answers to another recipient 110, then the method 240b branches to step 245 (FIG. 2).

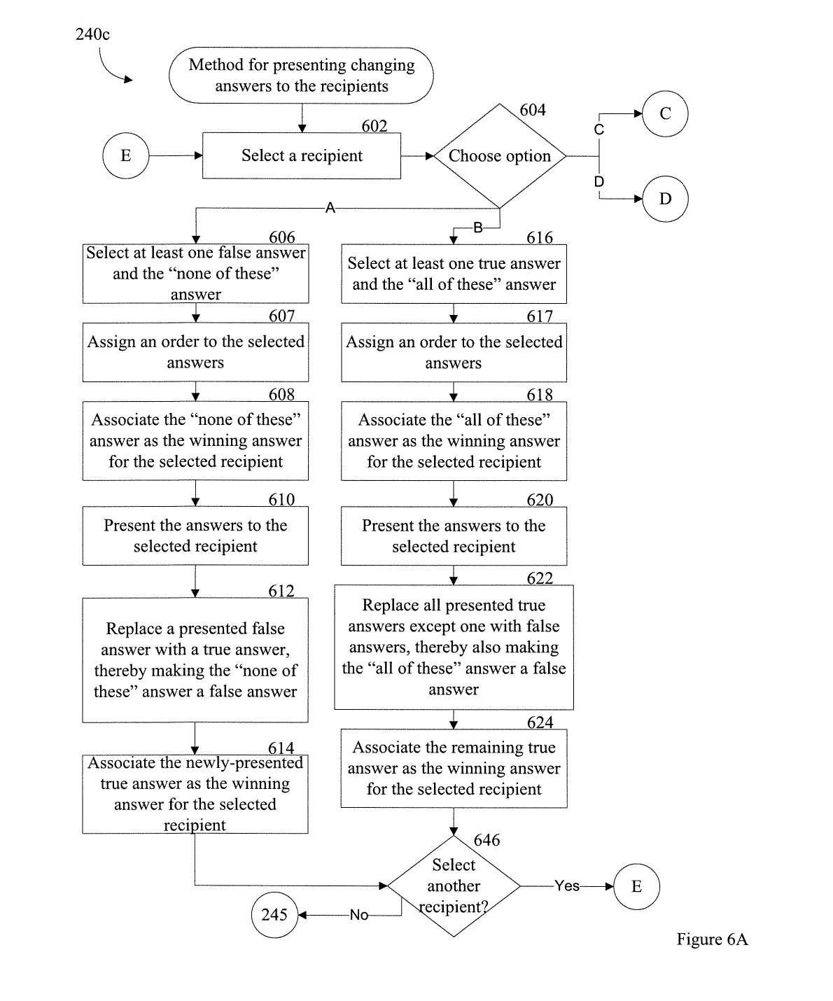

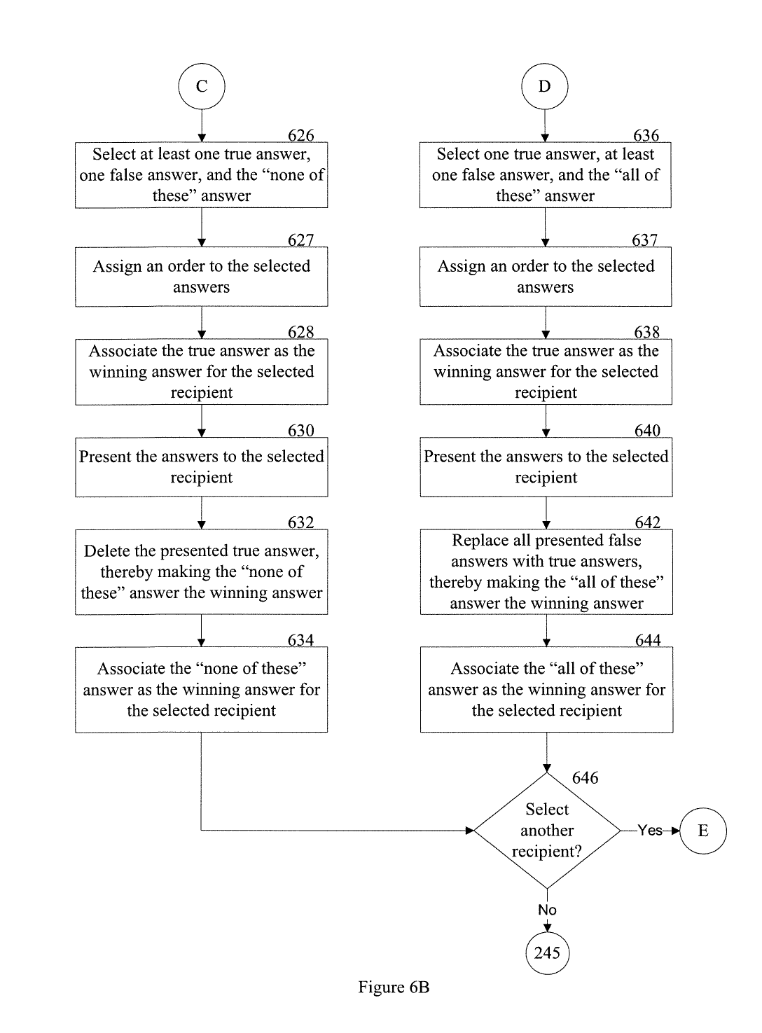

FIGS. 6A and 6B are flow charts depicting a method 240c for presenting changing answers to the recipients 110 according to an exemplary embodiment of the invention, as referenced in step 240 of FIG. 2. The method 240c will be described with reference to FIGS. 1, 6A, and 6B.

In step 602, the answer module 104 selects a recipient 110. In an exemplary embodiment, the answer module 104 can select a recipient 110 in a manner similar to the selection discussed above with reference to step 430 of FIG. 4.

In step 604, the answer module 104 chooses an option for presenting the changing answers to the recipients 110. As illustrated in FIG. 6A, the answer module 104 can choose between four options.

If the answer module 104 chooses option A, then the method 240c branches to step 606. In step 606, the answer module 104 selects at least one false answer to the question and the “none of these” answer. In this case, the “none of these” answer will be the first winning answer presented to the recipient. Then, in step 607, the answer module 104 assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer. In an exemplary embodiment, the answer module 104 can randomly assign an order to the selected answers.

In step 608, the answer module 104 associates the “none of these” answer as the winning answer for the selected recipient 110 and stores that information for later use.

In step 610, the answer module 104 presents the answers to the selected recipient 110 via the response device 112 utilized by the selected recipient 110. Then, in step 612, the answer module 104 replaces a presented false answer with a newly-presented true answer, thereby making the “none of these” answer an incorrect answer. The replacement also makes the newly-presented true answer the winning answer for the selected recipient 110. Accordingly, in step 614, the answer module 104 associates the newly-presented true answer as the winning answer for the selected recipient 110 and stores that information for later use.

The method 240c then proceeds to step 646. In step 646, the method 240c determines whether to select another recipient 110 to which it will present another set of changing answers. If yes, then the method branches back to step 602 to select another recipient 110 and to present a set of changing answers to the newly-selected recipient 110. Alternatively, if the method 240c determines in step 646 not to present a set of changing answers to another recipient 110, then the method branches to step 245 (FIG. 2).

Referring back to step 604, if the answer module 104 chooses option B for presenting the changing answers to the recipients 110, then the method branches to step 616. In step 616, the answer module 104 selects at least one true answer and the “all of these” answer. In this case, the “all of these” answer will be the first winning answer presented to the recipient. Then, in step 617, the answer module 104 assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer. In an exemplary embodiment, the answer module 104 can randomly assign an order to the selected answers.

In step 618, the answer module 104 associates the “all of these” answer as the winning answer for the selected recipient 110 and stores that information for later use.

In step 620, the answer module 104 presents the answers comprising the selected answers to the selected recipient 110 via the response device 112 utilized by the selected recipient 110. Then, in step 622, the answer module 104 replaces all presented true answers except one with false answers, thereby making the “all of these” answer an incorrect answer. The replacement also makes the remaining true answer the winning answer for the selected recipient 110. Accordingly, in step 624, the answer module 104 associates the remaining true answer as the winning answer for the selected recipient 110 and stores that information for later use.

From step 624, the method 240c proceeds to step 646 discussed previously.

Referring back to step 604, if the answer module 104 chooses option C for presenting changing answers to the recipients 110, then the method 240c branches to step 626. In step 626, the answer module 104 selects at least one true answer, one false answer, and the “none of these” answer. In this case, the true answer will be the first winning answer presented to the recipient. Then, in step 627, the answer module 104 assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer. In an exemplary embodiment, the answer module 104 can randomly assign an order to the selected answers.

In step 628, the answer module 104 associates the true answer as the winning answer for the selected recipient 110 and stores that information for later use.

In step 630, the answer module 104 presents the answers to the selected recipient 110 via the response device 112 utilized by the selected recipient 110. Then, in step 632, the answer module 104 deletes the presented true answer, thereby making the “none of these” answer the winning answer for the selected recipient 110. Accordingly, in step 634, the answer module 104 associates the “none of these” answer as the winning answer for the selected recipient 110 and stores that information for later use.

The method 240c then proceeds to step 646 discussed previously.

Referring back to step 604, if the answer module 104 chooses option D for presenting changing answers to the recipients 110, then the method 240c branches to step 636. In step 636, the answer module 104 selects one true answer, at least one false answer, and the “all of these” answer. In this case, the true answer will be the first winning answer presented to the recipient. Then, in step 637, the answer module 104 assigns an order to the selected answers. For example, the answers can comprise multiple choice answers listed in either alphabetical or numerical order, with each answer being assigned to a number or letter in the order. For instance, the answers can comprise an answer “A” assigned to a first selected answer, an answer “B” assigned to a second selected answer, an answer “C” assigned to a third selected answer, and an answer “D” assigned to a fourth selected answer. In an exemplary embodiment, the answer module 104 can randomly assign an order to the selected answers.

In step 638, the answer module 104 associates the true answer as the winning answer for the selected recipient 110 and stores that information for later use.

In step 640, the answer module 104 presents the answers to the selected recipient 110 via the response device 112 utilized by the selected recipient 110. Then, in step 642, the answer module 104 replaces all presented false answers with true answers, thereby making the “all of these” answer the winning answer for the selected recipient 110. Accordingly, in step 644, the answer module 104 associates the “all of these” answer as the winning answer for the selected recipient 110 and stores that information for later use.

The method 240c then proceeds to step 646 discussed previously.

Accordingly, the method 240c can present changing answers to the recipients 110. A recipient 110 can select an answer before the answers change. As the answers change, the recipient 110 may have to select another answer to correctly respond to the question. In an exemplary embodiment, each recipient 110 can receive a different set of answers, which can change over time. Alternatively, each recipient 110 can receive the same initial set of answers, which can change over time for some or all of the recipients 110. Thus, collusion between the recipients 110 is deterred because the recipients 110 do not know if the correct answer is the same for the colluding recipients 110. Additionally, the recipients remain engaged throughout the period for response because they may need to change their selected answer as the presented answers change.

FIG. 7 is a flow chart depicting a method 250 for determining whether the recipients 110 correctly responded to the question according to an exemplary embodiment of the invention, as referenced in step 250 of FIG. 2. The method 250 will be described with reference to FIGS. 1 and 7.

In step 705, the answer module 104 selects a recipient 110 that submitted a response to the question. Then, in step 710, the answer module 104 identifies the stored, winning answer associated with the selected recipient 110.

In step 715, the answer module 104 reads the answer submitted in the selected recipient's response to the question. Then, in step 720, the answer module 104 determines whether the selected recipient's answer submitted in the response matches the winning answer associated with the selected recipient 110. If yes, then the method 250 branches to step 725, in which the answer module 104 records a correct answer for the selected recipient 110. The method 250 then proceeds to step 735 discussed later.

Referring back to step 720, if the answer module 104 determines that the selected recipient 110 answer submitted in the response does not match the correct answer associated with the selected recipient 110, then the method 250 branches to step 730. In step 730, the answer module 104 records an incorrect answer for the selected recipient 110. The method 250 then proceeds to step 735.

In step 735, the method 250 determines whether to select another recipient 110 to determine whether that recipient 110 correctly responded to the question. If yes, then the method 250 branches back to step 705 to repeat the process for another recipient 110. If not, then the method branches to step 255 (FIG. 2).

In an exemplary embodiment, the answer module 104 can perform the method 250 and can report the results of steps 725 and 730 to the host server 102. If the answer module 104 is located at the host server 102 or other central location, then the answer module 104 can perform the method 250 for multiple recipients 110. Alternatively, if the answer module 104 is deployed with a response device 112, then the answer module 104 may perform the method 250 only for recipients 110 using that response device 112. In an alternative exemplary embodiment, the host server 102 can perform the method 250 for multiple recipients 110.

FIG. 8 is a flow chart depicting a method 800 for playing a game using a question with different answers for multiple players according to an exemplary embodiment of the invention. The method 800 will be described with reference to FIGS. 1 and 8.

In step 805, the sponsor 101 creates a pool of questions and corresponding true, false, and potentially correct answers. As described previously, in exemplary embodiments, potentially correct answers can comprise a “none of these” answer, an “all of these” answer, a “none of the above” answer, and/or a “all of the above” answer. Also as described previously, in another exemplary embodiment, the questions can be based upon content shown on a broadcast network 106, and received by the recipients 110 on various types of receivers 108. Additionally, in an exemplary embodiment, the sponsor 101 can input the questions and answers into the host server 102, which can include an answer module 104. Then, in step 807, the answer module 104 selects a question and presents it to the recipients 110 of the question, who are the players of the game.

In step 810, the answer module 104 generates an initial answer set for each player or group of players. In an exemplary embodiment, the initial answer set can comprise a plurality of answers to be presented to the player initially. In a certain exemplary embodiment, the answer module 104 can select the answers in the initial answer set from the pool of true, false, and potentially correct answers created in step 805. In another exemplary embodiment, the answer module 104 also can select one or more additional answers from the pool that will not be part of the initial answer set, but which can be presented to the player at a later stage.

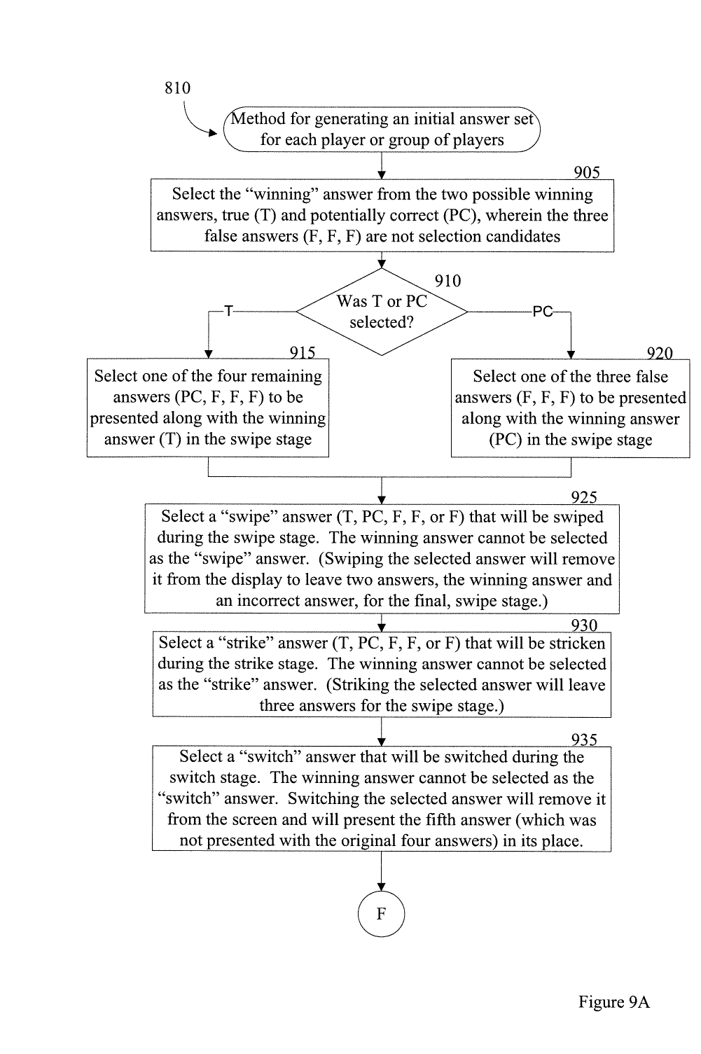

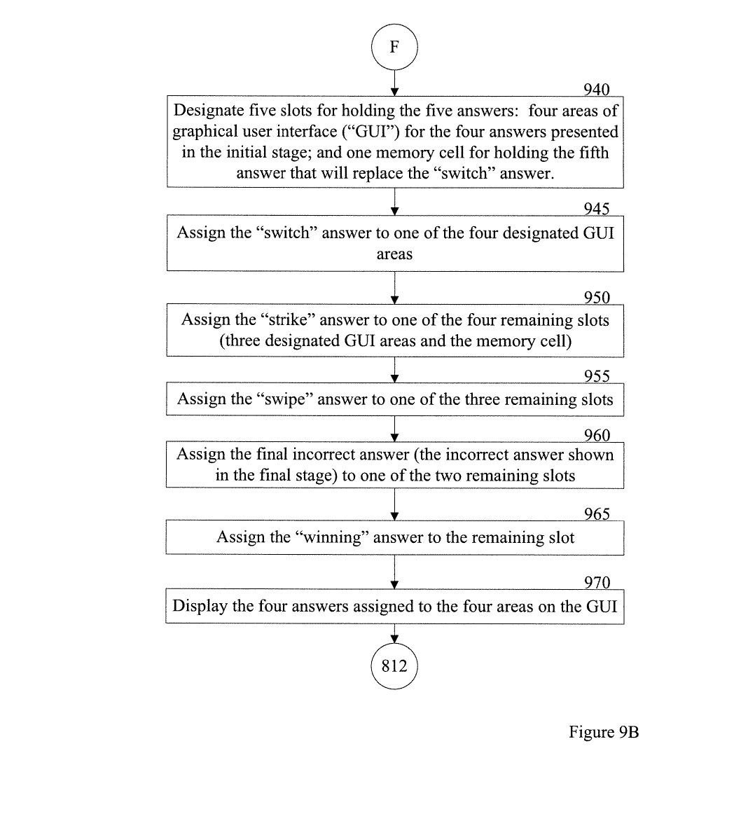

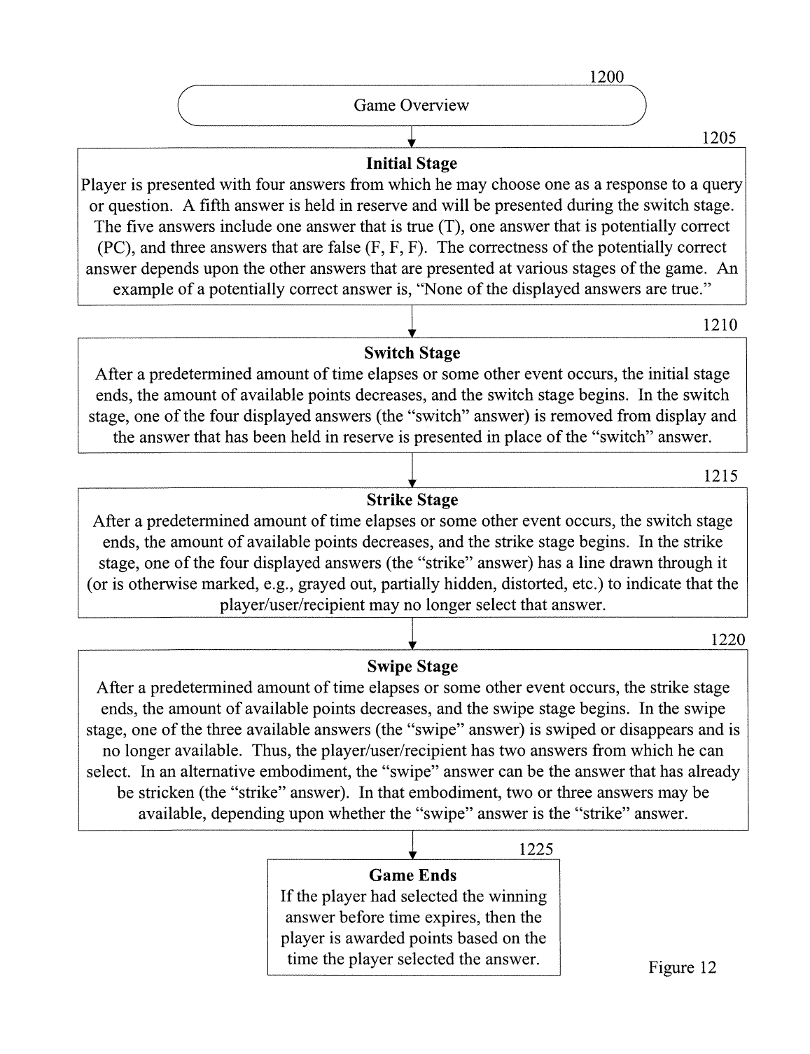

In another exemplary embodiment, the initial answer set can comprise four answers selected from a winning answer, an answer to be presented along with the winning answer during a final stage, a switch answer, a strike answer, and a swipe answer. The terms “switch answer,” “strike answer,” and “swipe answer” will be discussed in more detail with reference to FIG. 12. Step 810 will be described in more detail with reference to FIG. 9.

In step 812, the answer module 104 presents the initial answer set comprising the switch answer and three other answers. In an exemplary embodiment, all of the answers presented by the answer module 104 were created in step 805, and correspond with the question presented by the answer module 104.

In step 815, the answer module 104 begins counting the time period for allowing responses to the question. In various exemplary embodiments, this time period can be 5 seconds, 10 seconds, 15 seconds, 30 seconds, or 60 seconds, or any other suitable amount of time. In an exemplary embodiment, the answer module 104 can display the length of the time period. In another exemplary embodiment, the answer module 104 can display a continuously-updating counter corresponding with the amount of time remaining in the time period.

In step 817, the answer module 104 sets the points available for responding to the question correctly to a maximum value. In various exemplary embodiments, this maximum value can be 5 points, 10 points, 50 points, 100 points, 1000 points, or any other suitable point value. In an exemplary embodiment, the answer module 104 can display this maximum value to the player.

In step 820, the answer module 104 begins to decay (or decrease) the points available during the time period. In an exemplary embodiment, the points available can decrease as the remaining time in the time period decreases. In another exemplary embodiment, the answer module 104 can display the points available, and continuously update the display as the available points decrease. In an alternative exemplary embodiment, the available points can decrease only when the answer choices change. In another alternative exemplary embodiment, the points available do not decrease.

In step 822, the method 800 determines whether the player has selected an answer from the initial answer set. If the player has selected an answer, the method 800 branches to step 825. Otherwise, the method 800 branches to step 827. In exemplary embodiments, the player can select an answer by any of the methods described previously and by utilizing any of the response devices 112 described previously.

In step 825, the answer module 104 assigns a point value for the selected answer based on points available at the time when the player selected the answer. In an exemplary embodiment, the answer module 104 can determine the amount of time the player took to select an answer, and then assign a point value based on that amount of time. In another exemplary embodiment, the answer module 104 can continuously calculate and update the points available to a player based on the time remaining in the period, as described previously. In such an embodiment, the assigned value can be the updated value of the points available whenever the player selects an answer. The method 800 then proceeds to step 827.

In step 827, the answer module 104 replaces the switch answer on the display with a previously unpresented answer to create a “switch stage answer set” that is presented to the player. This stage can be called the switch stage. In an exemplary embodiment, the unpresented answer can comprise an answer that was created in step 805 but not presented in step 812 as part of the initial answer set, as discussed previously with respect to step 810.

In another exemplary embodiment, the answer module 104 can remove, strike through, or change the color of the switch answer on the display, and then add the unpresented answer to the display. In an exemplary embodiment, after step 827 the player cannot select the switch answer as a response to the question.

In step 830, the method 800 determines whether the player has selected an answer from the switch stage answer set. If the player has selected an answer, the method 800 branches to step 832. Otherwise, the method 800 branches to step 835.

In step 832, the answer module 104 assigns a point value for the selected answer based on points available at the time when the player selected the answer, as described previously with respect to step 825. The method 800 then proceeds to step 835.

In step 835, the answer module 104 crosses out the strike answer on the display to create a “strike stage answer set” that is presented to the player. This stage can be called the strike stage. In an alternative exemplary embodiment, the answer module 104 can partially conceal, change the color of the strike answer on the display, or otherwise indicate that the player may not select the strike answer. In an exemplary embodiment, after step 835 the player can no longer select the strike answer as a response to the question.

In step 837, the answer module 104 determines whether the player has selected an answer from the strike stage answer set. If the player has selected an answer, the method 800 branches to step 840. Otherwise, the method 800 branches to step 842.

In step 840, the answer module 104 assigns a point value for the selected answer based on points available at the time when the player selected the answer, as described previously with respect to step 825. The method 800 then proceeds to step 842.

In step 842, the answer module 104 removes the swipe answer from the display to create a “swipe stage answer set” that is presented to the player. This stage can be called the swipe stage. In an alternative exemplary embodiment, the answer module 104 can partially or completely conceal the swipe answer on the display or otherwise indicate that the player may not select the strike answer. In an exemplary embodiment, after step 842 the player cannot select the swipe answer as a response to the question.

In step 845, the answer module 104 determines whether the player has selected an answer from the swipe stage answer set. If the player has selected an answer, the method 800 branches to step 847. Otherwise, the method 800 branches to step 850.

In step 847, the answer module 104 assigns a point value for the selected answer based on points available at the time when the player selected the answer, as described previously with respect to step 825. The method 800 then proceeds to step 850.

In step 850, the time period for selecting an answer to the question ends. In an exemplary embodiment, the player cannot respond to the question at this point. In another exemplary embodiment, the answer module 104 can display a notification that the time period has ended. When the time period for selecting an answer ends, the answer previously selected by the player is the player's “final answer.”

In step 852, the answer module 104 determines whether the final answer selected by the player was the winning answer. In an exemplary embodiment, the answer module 104 can compare the final answer selected by the player with the winning answer for the question.

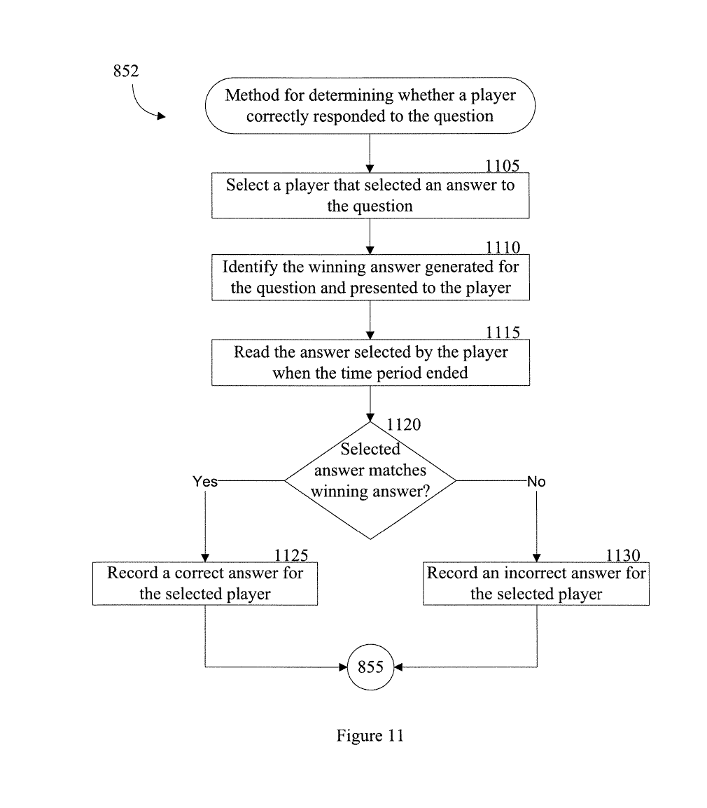

In an exemplary embodiment, the correct answer to the question (but not the winning answer) can differ from stage to stage. For example, if during one stage, the answers presented are a true answer, two false answers, and a “none of these” answer, the correct answer during that stage is the true answer. However, if during a subsequent stage, the true answer has been switched for a false answer, stricken, or swiped, then the correct answer during that stage is the “none of these” answer. In such an embodiment, the winning answer is the answer that correctly responds to the question when the time period for responding ends. Step 852 will be discussed in further detail hereinafter with reference to FIG. 11.

Then, in step 855, the method 800 determines whether the player selected the winning answer based on the results of step 852. If the player selected the winning answer, the method 800 branches to step 857. In step 857, the answer module 104 awards the assigned points to the player. The points assigned to the player can be those points assigned in steps 825, 832, 840, and/or 847, depending on the point at which the player selected the winning answer to the question (and did not change the answer thereafter). The method 800 then proceeds to step 862.

Referring back to step 855, if the method 800 determines that the player did not select the winning answer, then the method 800 branches to step 860.

In step 860, the answer module 104 awards zero points or negative points to the player. In an exemplary embodiment, the player can receive zero points for an incorrect answer. Alternatively, the player can receive negative points for an incorrect answer. In an exemplary embodiment, players can be informed prior to playing the game whether or not points will be deducted from their scores if they respond incorrectly. Deducting points for incorrect answers can discourage players from randomly guessing in response to questions. Thus, point deduction also can encourage players to pay attention to the content shown on the broadcast networks 106 when questions are based on that content and to try to respond to the questions based on that content correctly. The method 800 then proceeds to step 862.

In step 862, the method 800 determines whether another player answered the same question. If another player did answer the same question, the method 800 returns to step 852. Thus, the method 800 allows questions to be presented multiple players and can process the points awarded to each player. If another player did not answer the same question, the method 800 branches to step 865.

In step 865, the method 800 determines whether the answer module 104 will present another question to the players of the game. If the answer module 104 presents another question, the method 800 returns to step 807. Thus, the method 800 allows multiple questions to be presented to the players during a game, and points can be aggregated for the players for each of the questions. If the answer module 104 will not present another question, the method 800 branches to step 867. In step 867, the answer module 104 determines the winning player based on the points totals for each of the players. In an exemplary embodiment, the point total for each player can be the sum of points the player was awarded for all questions. The method 800 then ends.

When performing the method 800, questions can be presented to multiple players simultaneously. Then, the method 800 can simultaneously monitor for answer selections by each player and can assign points to each respective player based on the time when the each respective player selects an answer. Additionally, the answer module 104 can perform some or all of the steps in the method 800.

FIGS. 9A and 9B are flowcharts depicting a method 810 for generating an initial answer set for a question according to an exemplary embodiment of the invention, as referenced in step 810 of FIG. 8. The method 810 will be described with reference to FIGS. 1, 9A, and 9B.

In step 905, the answer module 104 selects the winning answer from the two possible winning answers (i.e., the true answer and potentially correct answer) in the pool of answers for a particular question, wherein the three false answers are not selection candidates. In other embodiments, the answer module 104 can select a winning answer from any number of potentially correct answers for the question.

In step 910, the answer module 104 determines whether the true answer or the potentially correct answer was selected in step 905. If the true answer was selected, the method 810 branches to step 915.

In step 915, the answer module 104 selects one of the four remaining answers (i.e., the potentially correct answer or the three false answers) to be presented along with the winning answer (i.e., the true answer) in the swipe stage. In one exemplary embodiment, the winning answer will be presented with only one other answer during the swipe stage. In an alternative embodiment, the winning answer will be presented along with two or more other answers during the swipe stage. The method 810 then proceeds to step 925.

Referring back to step 910, if the potentially correct answer was selected, the method 810 branches to step 920. In step 920, the answer module 104 selects one of the three false answers to be presented along with the winning answer (i.e., the potentially correct answer) in the swipe stage. As discussed previously, in various exemplary embodiments, the winning answer can be presented with one incorrect answer or with multiple incorrect answers during the final stage. The method 810 then proceeds to step 925.

In step 925, the answer module 104 selects a swipe answer that will be swiped during the swipe stage. The winning answer cannot be selected as the swipe answer, because the player would not be able to select the winning answer in response to the question. Swiping the answer selected in step 925 will remove it from the display to leave two answers: the winning answer and one incorrect answer for the final, swipe stage. In an alternative embodiment, as discussed previously, more than one incorrect answer can be displayed with the winning answer during the swipe stage.

In step 930, the answer module 104 selects a strike answer that will be stricken during the strike stage. The winning answer cannot be selected as the strike answer, because the player would not be able to select the winning answer in response to the question. Striking the answer selected in step 930 will leave three answers for the swipe stage: the winning answer and two incorrect answers for the strike stage. In an exemplary embodiment, the answer module 104 can obscure, change the color of, or otherwise alter the appearance of the strike answer during the strike stage, and prevent the player from selecting the strike answer in response to the question. In another exemplary embodiment, the strike answer selected in step 930 can comprise the same answer selected as the swipe answer in step 925. In such an embodiment, the winning answer can be displayed with two incorrect answers during the swipe stage, because the swipe stage merely removed the stricken answer.

In step 935, the answer module 104 selects a switch answer that will be switched during the switch stage. The winning answer cannot be selected as the switch answer, because the player would not be able to select the winning answer in response to the question. Switching the selected answer will remove it from the screen and will present the fifth answer (which not be presented with the four answers original in the initial answer set presented to the players) in its place. The method 810 then proceeds to step 940.

In step 940, the answer module 104 designates five slots for holding the five answers. The five slots include four areas of graphical user interface (“GUI”) for the four answers presented in the initial stage, and one memory slot for holding the fifth answer that will replace the switch answer during the switch stage. In an alternative exemplary embodiment, additional answers can be stored in additional slots, whether in the GUI section or in a slot for holding answers not initially presented to the player. The GUI section can represent an area on a receiver where an answer will be presented.

In step 945, the answer module 104 assigns the switch answer to one of the four designated GUI areas. Because the switch answer will be replaced with the answer not initially presented to the player, the switch answer should be in the GUI area before it is replaced.

In step 950, the answer module 104 assigns the strike answer to one of the four remaining slots (i.e., one of the three remaining designated GUI areas or the memory cell). In an exemplary embodiment, if the strike answer is placed in the memory cell, it may not be initially presented to the player, and instead it can replace the switch answer during the switch stage.

In step 955, the answer module 104 assigns the swipe answer to one of the three remaining slots. In an exemplary embodiment, if the swipe answer is placed in the memory cell, it may not be initially presented to the player, but instead it can replace the switch answer during the switch stage. As discussed previously, in another exemplary embodiment, the swipe answer can be the same as the strike answer. In such an embodiment, one of the slots can store an additional incorrect answer to be displayed with the winning answer during the final stage.

In step 960, the answer module 104 assigns the final incorrect answer (i.e., the incorrect answer shown in the final, swipe stage) to one of the two remaining slots. In an exemplary embodiment, this final incorrect answer can be the only incorrect answer presented with the winning answer during the final stage. In an alternative exemplary embodiment, multiple incorrect answers can be presented with the winning answer during the final stage.

In step 965, the answer module 104 assigns the winning answer to the remaining slot. Then, in step 970, the answer module 104 displays the four answers assigned to the four areas on the GUI to the player. The method 810 then proceeds to step 812, as referenced in FIG. 8.

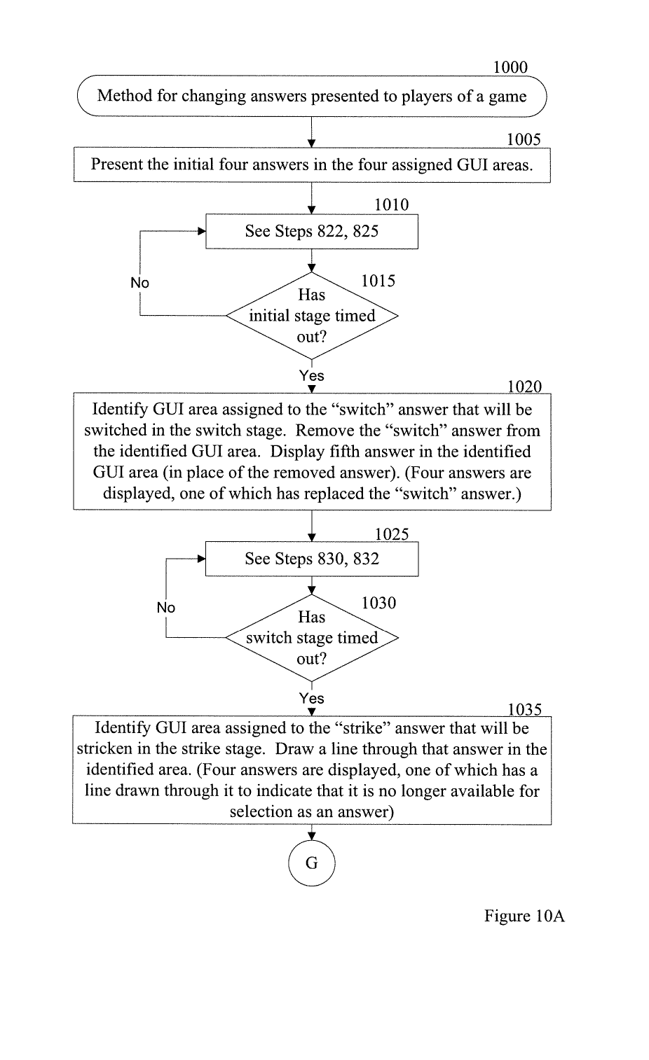

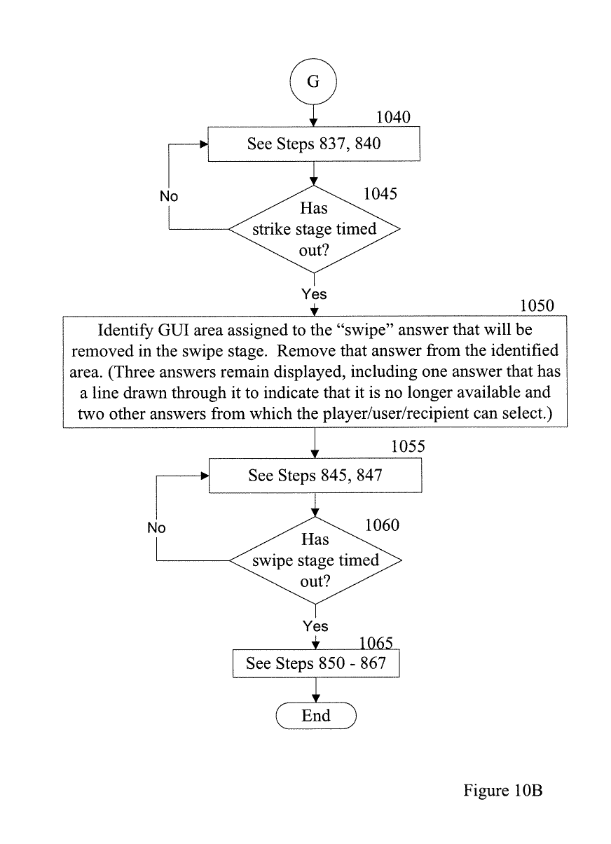

FIGS. 10A and 10B are flowcharts depicting a method 1000 for changing answers presented to players of a game according to an exemplary embodiment of the invention. The steps illustrated in FIGS. 10A and 10B describe additional aspects of displaying and changing answers in a graphical user interface as presented on a receiver 108, where certain steps described with reference to FIG. 10 provide additional, exemplary information related to certain corresponding steps in FIG. 8. For example, step 1005 corresponds to step 812; step 1020 corresponds to step 827; step 1035 corresponds to step 835; and step 1050 corresponds to step 842. The method 1000 will be described with reference to FIGS. 1, 10A and 10B.

In step 1005, the answer module 104 presents the initial four answers in the four assigned GUI areas. In an exemplary embodiment, the initial four answers can be selected by the method 810 described with reference to FIG. 9.

In step 1010, the answer module 104 determines whether the player has selected an answer from the initial four answers in response to the question, as referenced in step 822 of FIG. 8, and then assigns a point value for the selected answer based on the time elapsed, as referenced in step 825 of FIG. 8.

In step 1015, the method 1000 determines whether the initial stage has timed out. If the initial stage has not timed out, the method 1000 returns to step 1010 to monitor for an answer selection by the player. If the initial stage has timed out, the method 1000 branches to step 1020. In exemplary embodiments, the time period for the initial stage can be 3 seconds, 5 seconds, 10 seconds, or any other suitable amount of time.

In step 1020, the answer module 104 identifies the GUI area assigned to the switch answer that will be switched in the switch stage. The answer module 104 then removes the switch answer from the identified GUI area and displays the fifth answer in the identified GUI area (in place of the removed answer). At this point, four answers are displayed, one of which has replaced the switch answer.

In step 1025, the answer module 104 determines whether the player has selected an answer from the four answers presented during the switch stage, as referenced in step 830 of FIG. 8, and then assigns a point value for the selected answer based on the time elapsed, as referenced in step 832 of FIG. 8.

In step 1030, the method 1000 determines whether the switch stage has timed out. If the switch stage has not timed out, the method 1000 returns to step 1025 to monitor for an answer selection by the player. If the switch stage has timed out, the method 1000 branches to step 1035. In exemplary embodiments, the time period for the switch stage can be 3 seconds, 5 seconds, 10 seconds, or any other suitable amount of time.

In step 1035, the answer module 104 identifies the GUI area assigned to the strike answer that will be stricken in the strike stage. The answer module 104 then draws a line through the strike answer in the identified GUI area. At this point, four answers are displayed, one of which has a line drawn through it to indicate that it is no longer available for selection as an answer. In an alternative embodiment, as described previously, the answer module 104 can obscure, change the color of, or otherwise alter the appearance of the strike answer during the strike stage, and prevent the player from selecting the strike answer in response to the question. The method 1000 then proceeds to step 1040.

In step 1040, the answer module 104 determines whether the player has selected an answer from the three answers presented and available for selection during the strike stage, as referenced in step 837 of FIG. 8, and then assigns a point value for the selected answer based on the elapsed time, as referenced in step 840 of FIG. 8.

In step 1045, the method 1000 determines whether the strike stage has timed out. If the strike stage has not timed out, the method 1000 returns to step 1040 to monitor for an answer selection by the player. If the strike stage has timed out, the method 1000 branches to step 1050. In exemplary embodiments, the time period for the strike stage can be 3 seconds, 5 seconds, 10 seconds, or any other suitable amount of time.

In step 1050, the answer module 104 identifies the GUI area assigned to the swipe answer that will be removed in the swipe stage. The answer module 104 then removes that answer from the identified area. At this point, three answers are displayed, one of which (the strike answer) has a line drawn through it to indicate that it is no longer available for selection as an answer, and two other answers from which the player can select a response to the question. In an alternative embodiment, as described previously, the strike answer and the swipe answer can be the same, and the answer module 104 can remove the strike answer during the swipe stage. In such an embodiment, three answers are displayed, any of which are available to be selected by the player. The method 1000 then proceeds to step 1055.

In step 1055, the answer module 104 determines whether the player has selected an answer from the two answers presented and available for selection during the swipe stage, as referenced in step 845 of FIG. 8, and then assigns a point value for the selected answer based on the elapsed time, as referenced in step 847 of FIG. 8.

In step 1060, the method 1000 determines whether the swipe stage has timed out. If the swipe stage has not timed out, the method 1000 returns to step 1055 to monitor for an answer selection by the player. If the swipe stage has timed out, the method 1000 branches to step 1065. In an exemplary embodiment, the time period for the swipe stage can be 3 seconds, 5 seconds, 10 seconds, or any other suitable amount of time.

In step 1065, the answer module 104 performs steps 850 through 867, as described previously with reference to FIG. 8. These steps determine whether each player answered a question correctly, award points based upon the players' responses, and then determine a winning player based upon point totals for all questions. The method 1000 then ends.

FIG. 11 is a flow chart depicting a method 852 for determining whether a player correctly responded to a question according to an exemplary embodiment of the invention, as referenced in step 852 of FIG. 8. The method 852 will be described with reference to FIGS. 1 and 11.

In step 1105, the answer module 104 selects a player that selected an answer to the question. In an exemplary embodiment, many players can select an answer to the question, and the answer module 104 can select any one of those players. In various exemplary embodiments, the answer module 104 can select the player randomly, alphabetically, temporally, or by any other suitable method.

In step 1110, the answer module 104 identifies the winning answer generated for the question and presented to the player. In an exemplary embodiment, the winning answer can comprise only the answer that correctly responds to the question presented to the player after the swipe stage. For example, as described previously, during one stage the true answer can respond to the question correctly, but during another stage, after the true answer has been switched, stricken, or swiped, the potentially correct answer can respond to the question correctly. Therefore, different stages during the presentation of a question can have different correct answers that are identified by the answer module 104, but only the final winning answer is identified by the answer module 104 in step 1110.

In step 1115, the answer module 104 reads the final answer selected by the player when the time period ended. In an exemplary embodiment, the final answer read by the answer module 104 can comprise only the last answer the player selected before time expired.

In step 1120, the method 852 determines whether the final answer matches the winning answer. If the final answer matches the winning answer, the method 852 branches to step 1125, where the answer module 104 records a correct answer for the selected player. If the final answer does not match the winning answer, the method 852 branches to step 1130, where the answer module 104 records an incorrect answer for the selected player.

After performing either step 1125 or step 1130, the method 852 then proceeds to step 855, as referenced in FIG. 8.

FIG. 12 is a flow chart depicting a method 1200 for playing a game based on questions and dynamic multiple choice answers according to an exemplary embodiment of the invention. The method 1200 will be described with reference to FIGS. 1 and 12.

In step 1205, the answer module 104 enters an initial stage. In the initial stage, the player is presented with four answers from which the player can choose one as a response to a query or question. A fifth answer is held in reserve and will be presented during the switch stage. The five answers include one answer that is true, one answer that is potentially correct, and three answers that are false. The correctness of the potentially correct answer depends upon the other answers that are presented at various stages of the game. An example of a potentially correct answer is, “None of the displayed answers are true.”

In step 1210, the answer module 104 enters a switch stage. After a predetermined amount of time elapses or another event occurs, the initial stage ends, the amount of available points decreases, and the switch stage begins. In the switch stage, one of the four displayed answer (the switch answer) is removed from display and the answer that has been held in reserve is presented in place of the switch answer.

In step 1215, the answer module 104 enters a strike stage. After a predetermined amount of time elapses or another event occurs, the switch stage ends, the amount of available points decreases, and the strike stage begins. In the strike stage, one of the four displayed answers (the strike answer) has a line drawn through it (or is otherwise marked, grayed out, partially hidden, distorted, etc.) to indicate that the player may no longer select that answer.

In step 1220, the answer module 104 enters a swipe stage. After a predetermined amount of time elapses or another event occurs, the strike stage ends, the amount of available points decreases, and the swipe stage begins. In the swipe stage, one of the three available answers (the swipe answer) is swiped or disappears and is no longer available. Thus, the player has two answers from which to select. In an alternative embodiment, the swipe answer can be the answer that has already been stricken (i.e., the strike answer). In that embodiment, two or three answers may be available, depending upon whether the swipe answer is the strike answer.

In step 1225, the game ends. If the player had selected the winning answer before time expires, then the player is awarded points based on the time the player selected the answer.

An exemplary computer-implemented method for presenting answers to a plurality of recipients has been described and includes the steps of presenting media content to a first recipient and a second recipient; presenting a question based on the content to the first and second recipients; and presenting a first set of answers to the first recipient and a second set of answers to the second recipient, wherein the first and second sets of answers each comprise an answer that comprises a correct answer to the question, and wherein the first set of answers is different from the second set of answers.

In an exemplary embodiment, the method further includes the steps of receiving a response to the question from the first recipient, the response comprising a selected answer from the first set of answers; and determining whether the selected answer in the response comprises the correct answer to the question. In an exemplary embodiment, the step of presenting a first set of answers to the first recipient comprises associating the answer in the first set of answers that comprises the correct answer with the first recipient, and wherein the step of determining whether the selected answer in the response comprises the correct answer to the question comprises the step of determining whether the selected answer matches the answer associated with the first recipient. In an exemplary embodiment, the method further includes the step of qualifying the first recipient for a prize in response to a determination that the selected answer in the response comprises the correct answer to the question.

In an exemplary embodiment, the step of presenting a first set of answers to the first recipient and a second set of answers to the second recipient comprises the steps of selecting answers that will be included in the first and second sets of answers; randomly assigning a first order to the selected answers to create the first set of answers; and randomly assigning a second order to the selected answers to create the second set of answers, wherein the randomly assigning steps causes the first set of answers to be different from the second set of answers.

In an exemplary embodiment, the step of presenting a first set of answers to the first recipient and a second set of answers to the second recipient comprises the steps of selecting a first group of answers to include in the first set of answers; and selecting a second group of answers to include in the second set of answers, wherein the first group of selected answers is different from the second group of selected answers, thereby causing the first set of answers to be different from the second set of answers.

In an exemplary embodiment, the method further includes the step of changing the first set of answers to cause a different answer in the first set of answers to comprise the correct answer to the question. In an exemplary embodiment, the first set of presented answers comprises at least one incorrect answer and a “none of these” answer, wherein the “none of these” answer comprises the correct answer to the question, and wherein the step of changing the first set of answers comprises the step of replacing one of the presented at least one incorrect answers with a newly-presented correct answer comprising a correct answer to the question, thereby making the “none of these” answer an incorrect answer. In an alternative exemplary embodiment, the first set of presented answers comprises a first correct answer, a second correct answer, and an “all of these” answer, wherein the “all of these” answer comprises the correct answer to the question, and wherein the step of changing the first set of answers comprises the step of replacing the presented first correct answer with a newly-presented incorrect answer comprising an incorrect answer to the question, thereby making the second correct answer the correct answer.

In an exemplary embodiment, the first set of presented answers comprises a correct answer, an incorrect answer, and a “none of these” answer, wherein the correct answer comprises the correct answer to the question, and wherein the step of changing the first set of answers comprises the step of deleting the correct answer, thereby making the “none of these” answer the correct answer. In an exemplary embodiment, the first set of presented answers comprises a correct answer, an incorrect answer, and an “all of these” answer, wherein the correct answer comprises the correct answer to the question, and wherein the step of changing the first set of answers comprises the step of deleting the incorrect answer, thereby making the “all of these” answer the correct answer. In an exemplary embodiment, the method further includes the step of changing the second set of answers to cause a different answer in the second set of answers to comprise a correct answer to the question.

In exemplary embodiments, the content comprises an advertisement, a group of advertisements, a commercial, and/or a group of commercials. In an exemplary embodiment, the content comprises entertainment content. In an exemplary embodiment, a computer-readable medium has computer-executable instructions for performing the computer-implemented method.

An exemplary computer-implemented method for presenting answers to a plurality of recipients has been described and includes the steps of presenting a question to the recipients; presenting a first set of answers to one of the recipients, wherein one of the answers in the first set of answers comprises a first correct answer to the question; and presenting a second set of answers to another one of the recipients, wherein one of the answers in the second set of answers comprises a second correct answer to the question, wherein the first set of answers is different than the second set of answers. In an exemplary embodiment, the first set of answers is different than the second set of answers because the order of the answers is different in the first and second sets of answers. In an exemplary embodiment, the steps of presenting the first and second sets of answers comprise randomly assigning an order to the answers, thereby creating the different order of the answers in the first and second sets of answers.

In an exemplary embodiment, the first and second correct answers are the same answer to the question. In an alternative exemplary embodiment, the first set of answers is different than the second set of answers because at least one of the answers in the first set of answers is different from the answers in the second set of answers. In an exemplary embodiment, the method further includes the step of changing the answers in the first set of answers to create an answer that comprises a different correct answer to the question. In another exemplary embodiment, a computer-readable medium has computer-executable instructions for performing the computer-implemented method.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit of the invention. Accordingly, such alternative embodiments are included in the invention described herein.

The invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the invention defined in the following claims, the scope of which is to be accorded the broadest interpretation so as to encompass such modifications and equivalent structures.

What is claimed is:

1. A method for presenting a question and dynamic answers, comprising the steps of:
creating a question;
creating a plurality of potential answers for the question;
presenting the question;
presenting a first set of potential answers to the question during a first time period, the first set of potential answers comprising fewer than all of the plurality of potential answers;
altering the first set of potential answers to form a second set of potential answers;
presenting the second set of potential answers during a second time period;
and monitoring for a selection of an answer from the first and second sets of potential answers,
wherein a first potential answer of the plurality of potential answers is true, a second potential answer of the plurality of potential answers is potentially correct, and other potential answers of the plurality of potential answers are false.

2. The method of claim 1, wherein the step of altering the first set of potential answers to form a second set of potential answers comprises the step of removing one of the potential answers from the first set of potential answers.

3. The method of claim 1, wherein the step of altering the first set of potential answers to form a second set of potential answers comprises the steps of:
selecting one of the potential answers from the first set of potential answers as a stricken answer;
altering the stricken answer's appearance; and
preventing selection of the stricken answer in response to the question.

4. The method of claim 1, wherein the step of altering the first set of potential answers to form a second set of potential answers comprises the steps of:
removing one of the potential answers from the first set of potential answers; and
replacing the one potential answer removed from the first set of potential answers with one of the potential answers of the plurality of potential answers that was not included in the first set of potential answers.

5. The method of claim 1, further comprising the steps of:
altering the second set of potential answers to form a third set of potential answers;
presenting the third set of potential answers during a third time period; and
monitoring for a selection of an answer from the third set of potential answers.

6. The method of claim 4, further comprising the steps of:
altering the second set of potential answers to form a third set of potential answers;
presenting the player with the third set of potential answers during a third time period; and
monitoring for a selection of an answer from the third set of potential answers,
wherein the step of altering the second set of potential answers to form the third set of potential answers comprises the step of removing one of the potential answers from the second set of potential answers.

7. The method of claim 4, further comprising the steps of:
altering the second set of potential answers to form a third set of potential answers;
presenting the third set of potential answers during a third time period; and
monitoring for a selection of an answer from the third set of potential answers,
wherein the step of altering the second set of potential answers to form a third set of potential answers comprises the steps of selecting one of the potential answers from the second set of potential answers as a stricken answer, altering the stricken answer's appearance, and selection of the stricken answer in response to the question.

8. The method of claim 7, further comprising the steps of:
altering the third set of potential answers to form a fourth set of potential answers;
presenting the fourth set of potential answers during a fourth time period; and
monitoring for a selection of an answer from the third set of potential answers,
wherein the step of altering the third set of potential answers to form the fourth set of potential answers comprises the step of removing one of the potential answers from the third set of potential answers.

9. The method of claim 8, wherein the one potential answer removed from the third set of potential answers is the same as the stricken answer.

10. The method of claim 1, further comprising the steps of:
determining which answer was selected most recently based on the monitoring step;
determining whether the answer that was selected most recently matches a winning answer; and
awarding a number of points based on a determination that the answer that was selected most recently matches the winning answer.

11. The method of claim 10, wherein the step of awarding a number of points comprises the steps of:
assigning a point counter a maximum value;
decreasing the point counter value as time passes;
stopping the point counter from decreasing when an answer is selected based on the monitoring step; and
awarding points equal to the point counter value when the point counter is stopped in the stopping step.

12. The method of claim 1, wherein the step of creating a plurality of potential answers for the question comprises the steps of:
creating a list comprising the plurality of potential answers, wherein a first portion of the plurality of potential answers will be presented during the first time period, and wherein a second portion of the plurality of potential answers will not be presented to the player during the first time period;
creating a plurality of memory slots sufficient in number to store each of the plurality of potential answers;
storing the first portion of potential answers in a first portion of the plurality of memory slots; and
storing the second portion of potential answers in a second portion of the plurality of memory slots.

13. The method of claim 12, wherein the plurality of potential answers comprises one true answer, one potentially correct answer, and three false answers.

14. The method of claim 13, wherein the first portion of memory slots comprises four memory slots and wherein the second portion of memory slots comprises one memory slot.

15. The method of claim 14, wherein the first portion of memory slots comprises one memory slot for storing a winning answer, one memory slot for storing a swipe answer, one memory slot for storing a strike answer, and one memory slot for storing a switch answer, and wherein the second portion of memory slots comprises one memory slot for storing a substitute answer.

16. The method of claim 15, further comprising the step of selecting the winning answer from the true answer and the potentially correct answer.

17. The method of claim 16, further comprising the steps of:
if the winning answer comprises the true answer, selecting either the potentially correct answer or one of the three false answers to display with the true answer in a final stage, thereby leaving three remaining answers other than the winning answer and either the selected potentially correct answer or the selected one of the three false answers; and
if the winning answer comprises the potentially correct answer, selecting one of the three false answers to display with the potentially correct answer in the final stage, thereby leaving three remaining answers other than the winning answer and the selected one of the false answers.

18. The method of claim 17, further comprising the steps of:
selecting the swipe answer from the three remaining answers, thereby leaving two remaining answers;
selecting the strike answer from the two remaining answers, thereby leaving one remaining answer; and
selecting the one remaining answer as the switch answer.

19. The method of claim 1, wherein the plurality of potential answers comprises one true answer, one potentially correct answer, and three false answers.

20. The method of claim 1, further comprising the step of presenting media content to the player, wherein the question is based on the media content.

21. The method of claim 20, wherein the media content comprises an advertisement.

22. The method of claim 20, wherein the media content comprises a group of advertisements, and wherein the question is based on the content of one of the advertisements.

23. The method of claim 20, wherein the media content comprises entertainment content.

24. A computer-readable medium having computer-executable instructions for performing the method of claim 1.

25. A method for generating a first set of potential answers for a question, comprising the steps of:
creating the question;
creating a list comprising a plurality of potential answers for the question, wherein a first portion of the plurality of potential answers will be presented to the player during a first time period, and wherein a second portion of the plurality of potential answers will not be presented to the player during the first time period;
creating a plurality of memory slots sufficient in number to store each of the plurality of potential answers;
storing the first portion of potential answers in a first portion of the plurality of memory slots; and
storing the second portion of potential answers in a second portion of the plurality of memory slots.

26. The method of claim 25, wherein the plurality of potential answers comprises one true answer, one potentially correct answer, and three false answers.

27. The method of claim 26, wherein the first portion of memory slots comprises four memory slots and wherein the second portion of memory slots comprises one memory slot.

28. The method of claim 27, wherein the first portion of memory slots comprises one memory slot for storing a winning answer, one memory slot for storing a swipe answer, one memory slot for storing a strike answer, and one memory slot for storing a switch answer, and wherein the second portion of memory slots comprises one memory slot for storing a substitute answer.

29. The method of claim 28, further comprising the step of selecting the winning answer from the true answer and the potentially correct answer.

30. The method of claim 29, further comprising the steps of:
if the winning answer comprises the true answer, selecting either the potentially correct answer or one of the three false answers to display with the true answer in a final stage, thereby leaving three remaining answers; and
if the winning answer comprises the potentially correct answer, selecting one of the three false answers to display with the potentially correct answer in the final stage, thereby leaving three remaining answers.

31. The method of claim 30, further comprising the steps of:
selecting the swipe answer from the three remaining answers, thereby leaving two remaining answers;
selecting the strike answer from the two remaining answers, thereby leaving one remaining answer; and
selecting the one remaining answer as the switch answer.

32. A computer-readable medium having computer-executable instructions for performing the method of claim 25.
